(19) United States
(12) Patent Application Publication
(10) Pub. No.: US 2006/0282470 A1
(43) Pub. Date: Dec. 14, 2006

(54) Determining compliance of a database architecture to an enterprise data standard

(76) Inventors: Hong-Lee Yu, Woodinville, WA (US); Hemant Satchidanand Kolwalkar, Renton, WA (US); Brendan Thomas McNichols, Bothell, WA (US); Der-Ping Chou, Redmond, WA (US); Mary Ann Roth, San Jose, CA (US); Lingling Yan, San Jose, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/150,749

(22) Filed: Jun. 10, 2005

(51) Int. Cl. G06F 17/30

(52) U.S. Cl. 707/200

(57) ABSTRACT

Provided are a method, system, and program for determining compliance of a database architecture to an enterprise data standard. A physical model is generated defining database elements in a database. A logical model is provided representing a definition of elements and their relationships. The logical model is used to generate a mapping of database element names in the physical model to corresponding elements in the logical model. The mapping and the logical model are processed to determine an extent to which the database elements and relationships in the physical model violate rules of the logical model.

### BACKGROUND OF THE INVENTION

1. Field of the Invention

Provided are a method, system, and program for determining compliance of a database architecture to an enterprise data standard.

2. Description of the Related Art

An enterprise may maintain its databases in a specific format using an enterprise wide data standard for database elements, such as tables, fields, indexes, keys, views, functions, definitions, aliases, nicknames, etc. At certain points, the enterprise may acquire or may have previously developed legacy databases that define database elements, such as tables, fields (columns), indexes, etc., using a data standard different from the enterprise data standard. For instance, a company that maintains a customer and product database may acquire another related company that also maintains a customer and product database, but uses a different data standard for its database elements than the acquiring enterprise.

In the current art, the company wanting to integrate a source database into its enterprise database may have to hire a database engineer to manually alter the architecture of the source/legacy database to conform to the data standard and naming convention of the enterprise database. The process to conform another database to the enterprise naming convention may be quite extensive and time consuming, and require analysis of the source and target database architectures, developing translating terminology, forming dictionaries, matching the names from the source database to the target enterprise database, applying transformations such as join and filters to restructure the information, etc.

There is a need in the art for improved techniques for determining the extent to which a legacy database complies with an enterprise data standard during the process of integrating the legacy database with an enterprise database.

### SUMMARY

Provided are a method, system, and program for determining compliance of a database architecture to an enterprise data standard. A physical model is generated defining database elements in a database. A logical model is provided representing a definition of elements and their relationships. The logical model is used to generate a mapping of database element names in the physical model to corresponding elements in the logical model. The mapping and the logical model are processed to determine an extent to which the database elements and relationships in the physical model violate rules of the logical model.

### BRIEF DESCRIPTION OF THE DRAWINGS

FIG. 1 illustrates an embodiment of a computing environment in which a database may be converted to another format.

FIG. 2 illustrates an example of a logical model representation of a database.

FIGS. 3, 4, and 5 illustrate physical model implementations of the logical model of FIG. 2.

FIG. 6 illustrates an embodiment of a dictionary entry in the naming dictionary.

FIGS. 7 and 8 illustrate embodiments of operations to map database elements in a physical model to an enterprise logical model to determine compliance with an enterprise data standard.

FIG. 9 illustrates an embodiment of operations to generate a user interface showing a mapping of database elements in a first physical to database elements in a second physical model.

FIG. 10 illustrates an embodiment of the user interface showing the mapping of database elements in the first physical model to database elements in the second physical model.

### DETAILED DESCRIPTION

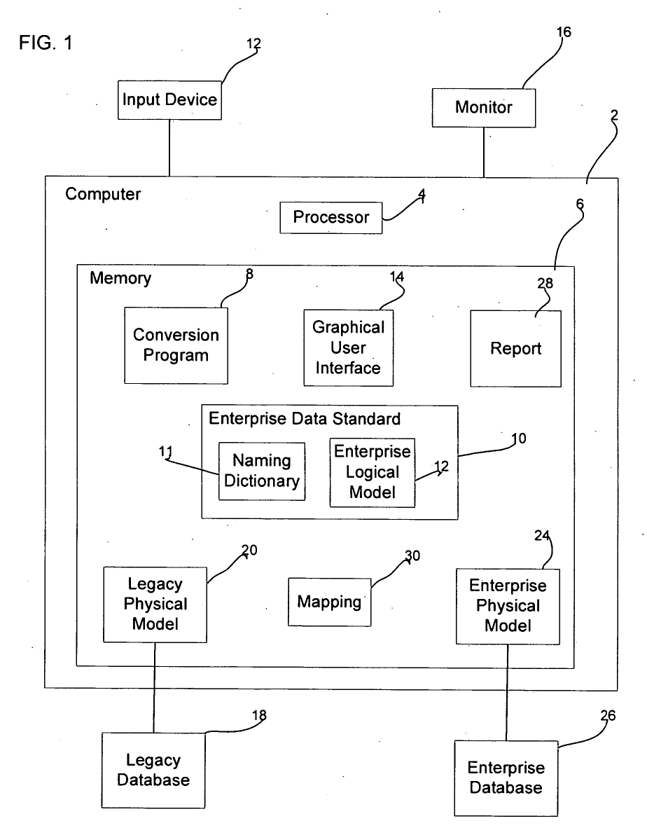

FIG. 1 illustrates a computer system 2 having a processor 4 and a memory 6, such as one or more volatile memory devices. The memory 6 includes a conversion program 8 to convert a database having a first design or architecture, such as a legacy database 18, to a database conforming to an enterprise naming convention, such as an enterprise database 26. An enterprise standard model 10 provides information on requirements of an enterprise standard. The enterprise standard model 10 may include one or more naming dictionaries 11 providing a mapping of database element names, such as abbreviations or synonyms, and the enterprise name for that element. Further, the enterprise standard model 10 may include one or more logical models 12 that provide information on relationships of the database elements, rules, invariants, constraints, types/domains, etc. for the enterprise. The logical models 12 may define an Entity Data Relationship (ERD) having entity types and relationships between entities that may be displayed in a pictorial format. The entities in the logical models 12 comprise the data types for the enterprise data standard, and may further define database elements, such as table names, field names in the tables, primary and alternate indexes on the tables, relationships between fields (e.g., primary and foreign keys), views, functions, definitions, aliases, nicknames. There may be multiple enterprise logical models 12 and corresponding naming dictionaries 11 in the enterprise data standard 10 providing the logical definitions of databases for different business entities.

Each entity may define data elements or attributes, having a name, definition, data type, length, etc. The conversion program 8 receives user input from an input device 12 (e.g., mouse, keyboard, pen stylus, voice activated input, touch sensitive display monitor, etc.) and renders a user interface 14 on a display monitor 16 to render information about the compliance and mapping of the legacy physical model 20 to the enterprise data standard 10. The legacy 18 and enterprise 26 databases may be implemented in a storage device in communication with the computer 2. The computer 2 may interface with the databases 18 and 26 over a bus interface, network interface, wireless connection or other suitable data communication interfaces known in the art.

The conversion program 8 is capable of processing the legacy database 18 implementation to generate a legacy physical model 20 that defines the database elements implemented in the legacy database 18, such as table names, field names in the tables, primary and alternate indexes on the tables, relationships between fields (e.g., primary and foreign keys), views, functions, definitions, aliases, nicknames, etc.

The conversion program 8 may determine a mapping 30 from the database elements and relationships in the legacy physical model 20 to the database as defined in the logical models 12 of the enterprise data standard 10 to ascertain to what extent the legacy physical model 20 is compliant with and maps to logical models 12 of the enterprise data standard 10. A physical model 20 and 24 may be converted to statements in a database programming language, such as the Structured Query Language (SQL), to code the database elements defined in the physical model 24 in the enterprise database 26.

The conversion program 8 may further generate a report 28 providing information on the results of the mapping 30 of the database elements, relationships, invariants, etc., in the legacy physical model 20 to the logical model 12 defining the enterprise data standard. This report 28 may indicate database elements of the legacy physical model 20 that did not map to the requirements of the enterprise data standard 10.

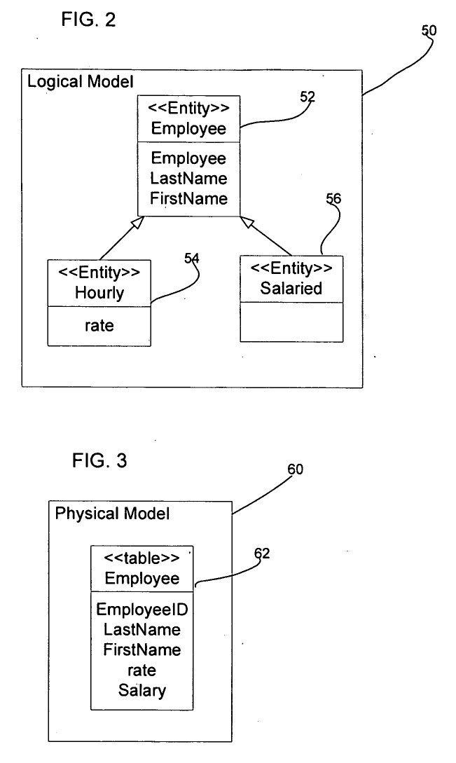

FIG. 2 illustrates an example of a logical model 50 having an employee entity 52 having data elements providing information on an employee, such as the employee name and ID. The logical model 50 further defines a relationship between the employee entity 52 and an hourly entity 54 and salaried entity 56 indicating whether the employee is paid a rate, which is a data element of the hourly entity 54, or receives a salary as represented by the salaried entity 56.

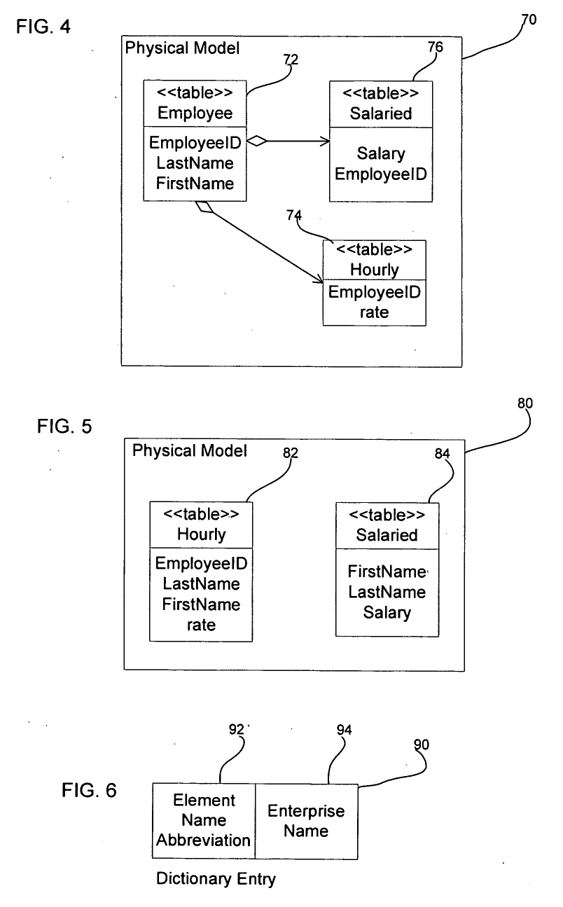

FIGS. 3, 4, and 5 provide physical models defining different implementations of how the entities defined in the logical model 50 may be implemented as database elements. FIG. 3 shows a physical model 60 where all the entities and their data elements in the logical model 50 are implemented in a single employee table 62. FIG. 4 shows a physical model 70 where the entities 52, 54, and 56 of the logical model 50 (FIG. 2) are each implemented in separate database tables 72, 74, and 76, respectively, that are related. FIG. 5 shows a physical model 80 where the entities of the logical model 50 are implemented in two different tables 82 and 84, and that the employee entity 52 data elements are implemented in both the hourly table 82 and salaried table 84.

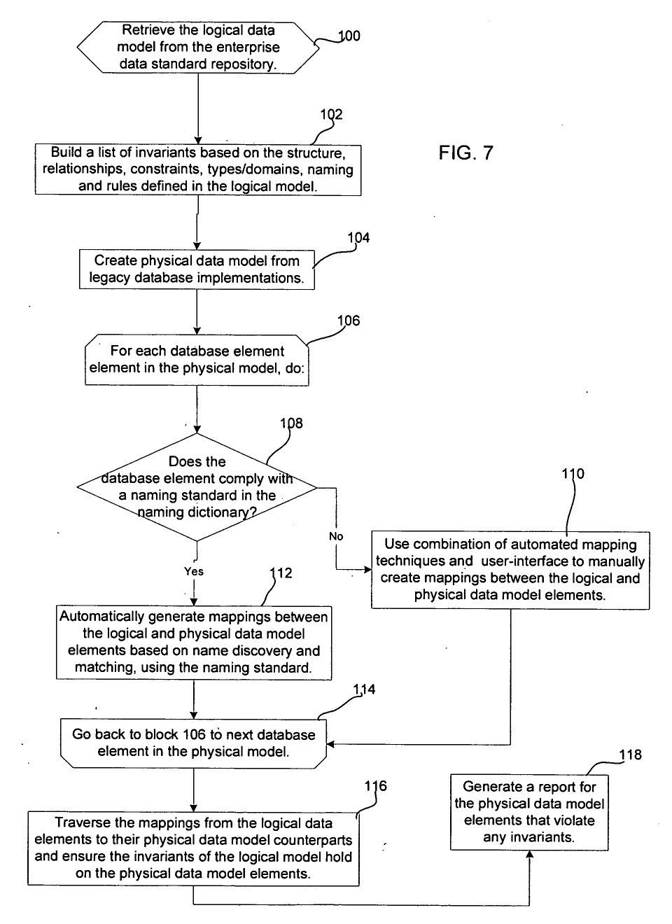

FIG. 6 illustrates an embodiment of an entry 90 in the naming dictionary 10, where an entry 90 is provided for each database element name that may map to an enterprise name conforming to the naming convention. The dictionary entry 90 includes an element name abbreviation 92 (or one or more synonyms of the name) of a database element type and a corresponding enterprise name 94 for that abbreviation. For instance, for the database element or entity type “employee”, the abbreviation may be “EMP”. Any database element having this string or stem defined in a physical model may then be determined to match the abbreviation. In such case, the enterprise name 94 for the matched element name abbreviation 94 may be used for the database element name found to match. For instance, the database element name in the physical model for “employee” may be substituted for the enterprise name for that element type. Different techniques may be used to match a database element name used in a physical model to the name abbreviation 92 in the naming dictionary 10 to find the enterprise name 94 corresponding to the specific name used in the physical mode.

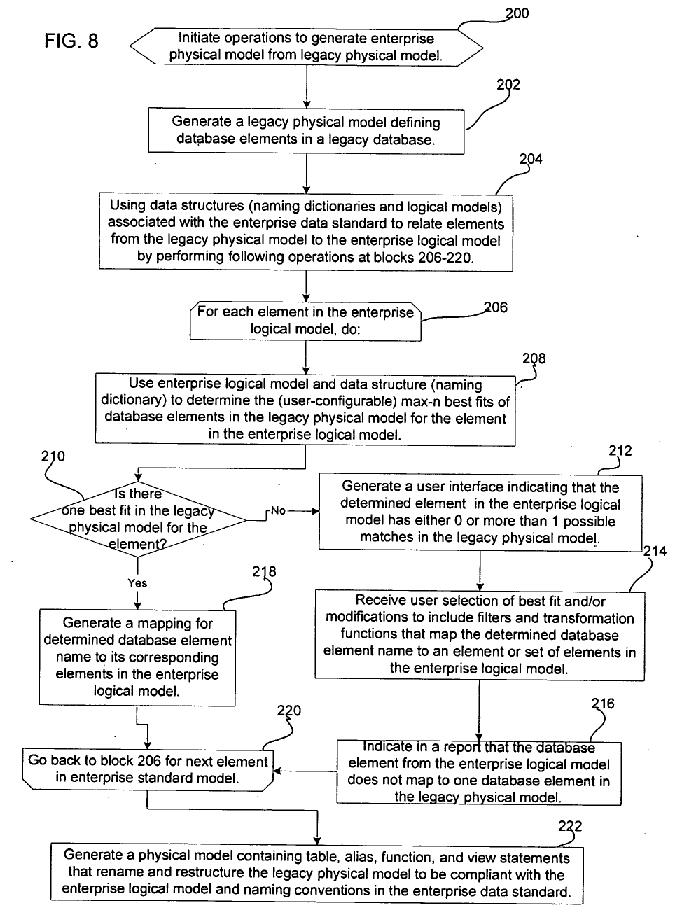

FIG. 7 illustrates an embodiment of operations implemented in the conversion program 8 (which may be one program or a combination of interacting programs and routines) to determine the extent to which the legacy database 18 architecture is compliant with the enterprise data standard 10. Control begins at block 100 with the conversion program 8 retrieving the logical model 12 from the enterprise data standard repository 10. A list of invariants is built (at block 102) based on the structure, relationships, constraints, types/domains, naming and rules defined in the logical model 12. The conversion program 8 creates (at block 104) a physical data model 20 from the legacy database 10 implementations. For the database elements in the legacy physical model 20 to map to the enterprise logical model 12, a loop is performed at blocks 106 through 114. A determination is made (at block 108) as to whether the database element complies with a naming standard in the naming dictionary 11. This compliance operation may involve determining whether the database element name in the physical model 20 matches an element name abbreviation 92. A combination of techniques may be used to determine a match, such as name comparison, data sampling, stemming, synonym comparison, semantic name matching with thesaurus and expansion lists, and specific naming models associated with both the physical model and the logical enterprise data standard to suggest matches.

If (at block 108) the database element name does not comply (match) with one element name abbreviation 92, then the conversion program 8 uses (at block 110) a combination of automated mapping techniques and user interfaces to manually create mappings 30 between the logical and physical data model elements. The automated mapping techniques may comprise additional comparison operations to determine whether the database elements from the physical model 20 match or correspond to one database element defined in the logical model 12. The copending and commonly assigned application entitled “TOLERANT AND EXTENSIBLE DISCOVERY OF RELATIONSHIPS IN DATA USING STRUCTURAL INFORMATION AND DATA ANALYSIS”, by Mauricio Antonio Hernandez, Ching-Tien H, Mary Ann Roth, and Lingling Yan, filed on Jun. 10, 2005, having attorney docket no. SVL920050003US1, and which application is incorporated herein by reference in its entirety, provides techniques for mapping database elements in a physical model to corresponding elements defined in logical model, such as an enterprise logical model 12. Further, if the automated techniques still fail to find correspondence, then the user may manually indicate a mapping 30 of one database element in the legacy physical model 20 to one element defined in the enterprise logical model 12. If (at block 108) the database element in the physical model 20 does comply, then the conversion program 8 automatically generates (at block 112) mappings 30 between the logical and physical data model elements based on name discovery and matching, using the naming standard defined in the naming dictionary 1.

After determining the mapping 30 at block 110 or 112, the conversion program 8 proceeds (at block 114) back to block 106 to determine a mapping for a further database element in the physical model 20. After determining the mappings 30 for all database elements in the physical model 20 to consider, the conversion program 8 traverses (at block 116) the mapping from the logical data elements to their physical data model counterparts and ensures the invariants of the logical model hold on the physical data model elements. The conversion program 8 may determine whether a database element in the physical model has relationships to other database elements in the physical model 20 that match the relationships the corresponding database element in the logical model 12 has with database elements in the logical model 12. For instance, if the physical model 20 has database element A having relationships with database elements C and D, the conversion program 8 determines whether the element A and its relationships C and D have correspondence to an element A′ in the logical model 12 and that A′ in the logical model 12 have a relationship with elements C′ and D′ that correspond/map to elements C and D in the physical model 20. The conversion program 8 may further check the extent to which the legacy physical model 20 elements and relationships comply with the rules and invariants defined in the enterprise logical model 12. The conversion program 8 further generates (at block 118) a report 28 for the physical data model elements that violate any invariants.

With the described embodiments, the conversion program 8 determines a mapping 30 and correspondence of the legacy physical model 20 database elements and relationships to the elements, relationships and rules defined in the enterprise logical model 12. The compliance of database elements in the physical model may be determined by using the naming dictionary 11. This information on the extent to which the physical model 12 does not comply with the enterprise data standard 10 may be presented to a database engineer to use when integrating the data from a legacy database 18 into the enterprise database 26.

FIG. 8 illustrates an embodiment of operations implemented in the conversion program 8 to generated a compliant enterprise physical model 24 from the legacy physical model 20. In FIG. 8, a compliant physical model is created when an existing enterprise data standard 10 and accompanying enterprise logical model 12 are present. Upon initiating (at block 200) operations to convert the legacy database 18 to an existing enterprise physical model 24 compliant with an enterprise data standard model 10, the conversion program 8 generates (at block 202) a physical model, e.g., the legacy physical model 20, defining database elements in a legacy database 18. The conversion program 8 uses (at block 204) data structures (naming dictionaries 11 and logical models 12) associated with both the enterprise data standard 10 to relate elements from the legacy physical model 20 in the mapping 30.

At blocks 206 through 220 a loop is performed for each database element in the enterprise logical model 12. At block 108, the conversion program 8 uses the logical model 12 and related data structures (naming dictionary 11) to determine for each data element in the enterprise standard model 10 the maximum n best fitting database elements in the legacy physical model 20 for the database element in the enterprise logical model 12 being considered. Alternatively, the conversion program 8 may use the model and data structure (naming dictionary 11) to determine for each database element in the legacy physical model 20 the (user-configurable) maximum n best fits of database elements in the enterprise logical model 12. If (at block 210) there are zero or more than one best fits in the legacy physical model 20 for that database element in the enterprise logical model 12, then a user interface 14 is generated (at block 212) indicating that the determined element in the enterprise standard model 10 (table, view, field, logical relationship, invariant, etc.) has either 0 or more than 1 possible matches in the legacy physical model 20. The conversion program 8 then receives (at block 214) user selection of the best fit and/or modifications to include filters and transformation functions that map the determined database element in the legacy physical model 20 to an element or set of elements in the enterprise logical model 12. The conversion program 8 further indicates (at block 216) enterprise elements in the enterprise logical model 12 that do not map to one or more database elements in the legacy physical model 20. Mappings and indication of no mappings may be made in the mapping 30.

If (at block 210) there is one best fit for the database element in the enterprise logical model 12, then the conversion program 8 generates (at block 218) a mapping in the mapping 30 for determined database element name in the legacy physical model 20 to its corresponding elements in the enterprise logical model 12. From block 216 or 218, control proceeds (at block 220) back to block 206 for a next element in the enterprise logical model 12. The conversion program 8 then generates (at block 222) a physical model 24 containing table, alias, function, and view statements that rename and restructure the legacy model to be compliant with the enterprise standard model. In this way, the generated mappings in the mapping 30 are used to generate the enterprise physical model 24 from the legacy physical model 20.

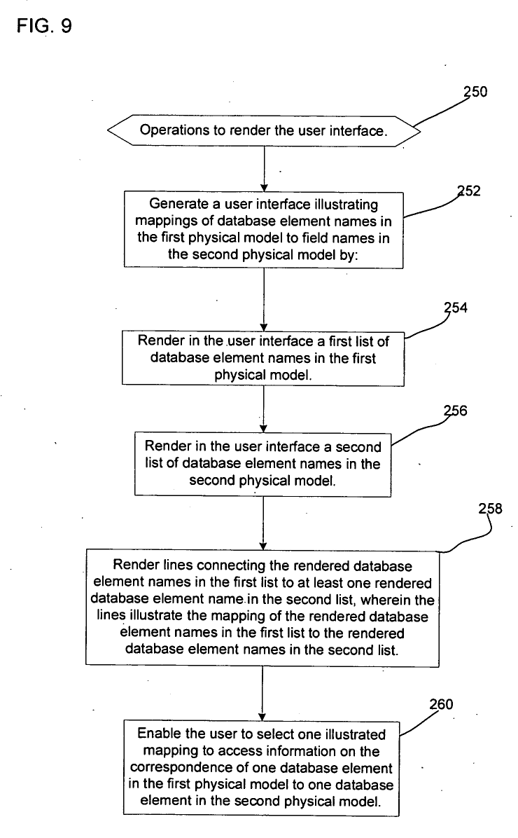

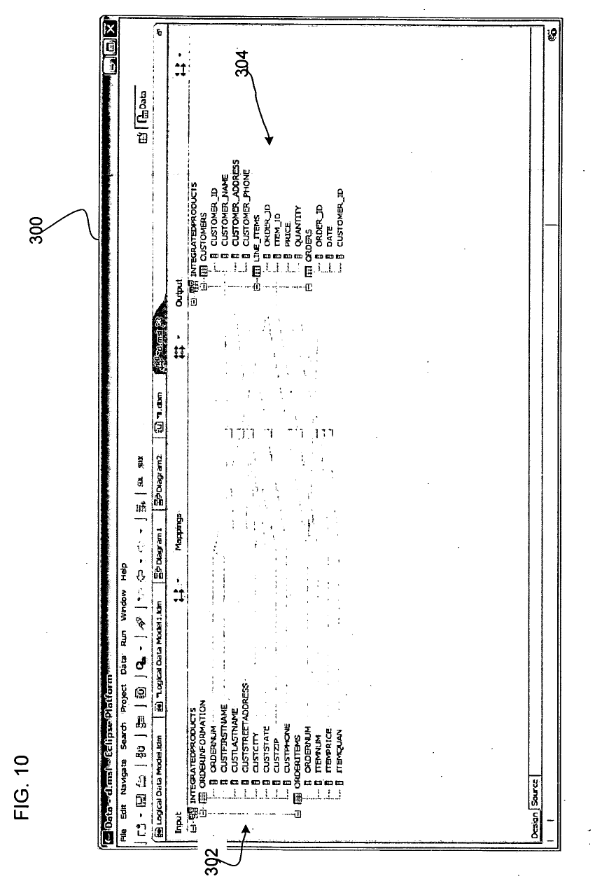

FIG. 9 illustrates an embodiment of operations implemented in the conversion program 8 to render information on a mapping of the database elements in the legacy database 18 to the database elements in the enterprise database 26. Upon initiating (at block 250) operations to render the user interface 14, a user interface 14 is generated (at block 252) illustrating mappings of database element names in the first physical model to field names in the second physical model. FIG. 10 provides an example of a user interface 300 showing how a first list 302 of database elements, e.g., from the legacy database 18, map to a second list 304 of database elements, such as in the enterprise database 26, to show the result of the mapping operations in FIGS. 7 and 8.

The operations at blocks 254 through 258 provide an embodiment of operations to generate the mappings. The conversion program 8 renders (at block 254 and 256) in the user interface 300 a first list 302 of database element names, such as from the legacy physical model 20, and a second list 304 of database element names, such as from the enterprise physical model 26. Further, lines are rendered (at block 258) connecting the rendered database element names in the first list 302 to at least one rendered database element name in the second list 304, wherein the lines illustrate the mapping of the rendered database element names in the first list to the rendered database element names in the second list. For instance, in FIG. 10, multiple database element names in the first list 302, such as “CUSTFIRSTNAME” and “CUSTLASTNAME” map to a single database element name in the second list 304, e.g., “CUSTOMER_NAME”. The lists 302 and 304 may comprise either the source or target database involved in the transformation.

The conversion program 8 may further enable the user to select one illustrated mapping, i.e., the lines connecting the database element names, to access information on the correspondence of one database element in the different physical models representing the different databases.

### Additional Embodiment Details

The described operations may be implemented as a method, apparatus or article of manufacture using standard programming and/or engineering techniques to produce software, firmware, hardware, or any combination thereof. The term “article of manufacture” as used herein refers to code or logic implemented in a medium, where such medium may comprise hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The computer readable medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In described embodiments, a legacy database 18 was checked for compliance with an enterprise data standard 10. In additional embodiments, the source database subject to the compliance checking may not comprise a legacy database, but any type of source database that needs to be checked. Further, the logical model used for the compliance checking may be part of any data standard, not just an enterprise data standard.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or that a different number of devices may be used than the multiple number shown.

The functionality and/or the features of a device may be alternatively embodied by one or more other devices which are not explicitly described as having such functionality/features. Thus, other embodiments of the present invention need not include the device itself.

The illustrated operations of FIGS. 7, 8, and 9 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method comprising:
generating a physical model defining database elements in a database;
providing a logical model representing a definition of elements and their relationships;
using the logical model to generate a mapping of database element names in the physical model to corresponding elements in the logical model;
processing the mapping and the logical model to determine an extent to which the database elements and relationships in the physical model violate rules of the logical model.

2. The method of claim 1, wherein one or more database elements in the physical model are capable of mapping to one or more elements in the logical model.

3. The method of claim 1, wherein the logical model defines elements and relationships for an enterprise data standard and wherein the physical model comprises a legacy physical model representing a legacy database to integrate into an enterprise database.

4. The method of claim 1, further comprising:
processing the logical model to build a list of invariants based on entities, relationships, constraints, types, namings, and rules defined in the logical model, wherein the processing of the mapping and the logical model to determine the extent to which the database elements and relationships in the physical model violates rules comprises determining whether the database elements and relationships comply with the rules indicated in the list of invariants.

5. The method of claim 4, further comprising:
generating a report providing information on the extent to which database elements and relationships in the physical model violate rules in the list of variants.

6. The method of claim 1, wherein using the logical model to generate a mapping of database names in the physical model to corresponding elements in the logical model further comprises:
processing a naming dictionary associated with the logical model to determine whether database elements in the physical model match element names defined in the naming dictionary; and
automatically generating a mapping between database elements in the physical model that match element names defined in the naming dictionary in response to determining that database elements in the physical model match element names defined in the naming dictionary.

7. The method of claim 6, wherein the naming dictionary associates database element names with synonyms of element names of the logical model, and wherein the database element in the physical model matches one element name in the dictionary if the database element in the physical model matches one element name synonym in the naming dictionary.

8. The method of claim 6, wherein using the logical model to generate a mapping of database names in the physical model to corresponding elements in the logical model further comprises:
receiving user input indicating a mapping between database elements in the physical model that do not match element names defined in the naming dictionary in response to determining that database elements in the physical model do not match element names defined in the naming dictionary.

9. The method of claim 8, further comprising generating a report indicating database elements in the physical model that did not match element names defined in the naming dictionary.

10. The method of claim 1, wherein using the logical model to generate a mapping of database names in the physical model to corresponding elements in the logical model further comprises:
determining whether there is one best fit between at least one database element in the physical model and at least one element in the logical model; and
generating a mapping between the at least one database element in the physical model having one best fit with at least one element in the logical model in response to determining that there is one best fit.

11. The method of claim 10, further comprising:
generating a user interface indicating that the at least one database element in the physical model does not have one best fit with at least one element in the logical model;
receiving user selection of a mapping between the at least one database element in the physical model and at then least one element in the logical model in response to determining that there is not one best fit.

12. The method of claim 11, further comprising generating a report indicating database elements in the physical model that do not have one best fit with at least one element in the logical mode.

13. The method of claim 1, wherein the physical model comprises a first physical model, further comprising:
generating a second physical model having database elements from the first physical model that comply with the logical model, wherein the generated mapping is used to determine how database element names in the first physical model map to database element names in the generated second physical model.

14. The method of claim 1, wherein the database elements comprise tables, views, relationships, functions, indexes, and fields.

15. The method of claim 1, wherein the physical model comprises a first physical model and wherein a second physical model provides a database implementation of the logical model, further comprising:
generating a user interface illustrating mappings of database element names in the first physical model to database element names in the second physical model; and
enabling the user to select one illustrated mapping to access information on the correspondence of one database element in the first physical model to one database element in the second physical.

16. The method of claim 15, wherein illustrating the mappings in the user interface comprises:
rendering in the user interface a first list of database element names in the first physical model;
rendering in the user interface a second list of database element names in the second physical model; and
rendering lines connecting the rendered database element names in the first list to at least one rendered database element name in the second list, wherein the lines illustrate the mapping of the rendered database element names in the first list to the rendered database element names in the second list.

17. A system in communication with a database, comprising:
a processor;
a logical model representing a definition of elements and their relationships; and
a computer readable medium including code executed by the processor to perform operations, the operations comprising:
generating a physical model defining database elements in the database;
using the logical model to generate a mapping of database element names in the physical model to corresponding elements in the logical model;
processing the mapping and the logical model to determine an extent to which the database elements and relationships in the physical model violate rules of the logical model.

18. The system of claim 17, wherein the logical model defines elements and relationships for an enterprise data standard and wherein the physical model comprises a legacy physical model representing a legacy database to integrate into an enterprise database.

19. The system of claim 17, wherein the operations further comprise:
processing the logical model to build a list of invariants based on entities, relationships, constraints, types, namings, and rules defined in the logical model, wherein the processing of the mapping and the logical model to determine the extent to which the database elements and relationships in the physical model violates rules comprises determining whether the database elements and relationships comply with the rules indicated in the list of invariants.

20. The system of claim 19, wherein the operations further comprise:
generating a report providing information on the extent to which database elements and relationships in the physical model violate rules in the list of variants.

21. The system of claim 17, wherein using the logical model to generate a mapping of database names in the physical model to corresponding elements in the logical model further comprises:
processing a naming dictionary associated with the logical model to determine whether database elements in the physical model match element names defined in the naming dictionary; and
automatically generating a mapping between database elements in the physical model that match element names defined in the naming dictionary in response to determining that database elements in the physical model match element names defined in the naming dictionary.

22. The system of claim 21, wherein using the logical model to generate a mapping of database names in the physical model to corresponding elements in the logical model further comprises:
receiving user input indicating a mapping between database elements in the physical model that do not match element names defined in the naming dictionary in response to determining that database elements in the physical model do not match element names defined in the naming dictionary.

23. The system of claim 17, wherein using the logical model to generate a mapping of database names in the physical model to corresponding elements in the logical model further comprises:
determining whether there is one best fit between at least one database element in the physical model and at least one element in the logical model; and
generating a mapping between the at least one database element in the physical model having one best fit with at least one element in the logical model in response to determining that there is one best fit.

24. The system of claim 23, wherein the operations further comprise:
generating a user interface indicating that the at least one database element in the physical model does not have one best fit with at least one element in the logical model;
receiving user selection of a mapping between the at least one database element in the physical model and at then least one element in the logical model in response to determining that there is not one best fit.

25. The system of claim 17, wherein the physical model comprises a first physical model, wherein the operations further comprise:
generating a second physical model having database elements from the first physical model that comply with the logical model, wherein the generated mapping is used to determine how database element names in the first physical model map to database element names in the generated second physical model.

26. The system of claim 17, wherein the physical model comprises a first physical model and wherein a second physical model provides a database implementation of the logical model, further comprising:
generating a user interface illustrating mappings of database element names in the first physical model to database element names in the second physical model; and
enabling the user to select one illustrated mapping to access information on the correspondence of one database element in the first physical model to one database element in the second physical.

27. An article of manufacture including code in communication with a database and capable of causing operations to be performed, the operations comprising:
generating a physical model defining database elements in the database;
providing a logical model representing a definition of elements and their relationships;
using the logical model to generate a mapping of database element names in the physical model to corresponding elements in the logical model;
processing the mapping and the logical model to determine an extent to which the database elements and relationships in the physical model violate rules of the logical model.

28. The article of manufacture of claim 27, wherein one or more database elements in the physical model are capable of mapping to one or more elements in the logical model.

29. The article of manufacture of claim 27, wherein the logical model defines elements and relationships for an enterprise data standard and wherein the physical model comprises a legacy physical model representing a legacy database to integrate into an enterprise database.

30. The article of manufacture of claim 27, wherein the operations further comprise:
processing the logical model to build a list of invariants based on entities, relationships, constraints, types, namings, and rules defined in the logical model, wherein the processing of the mapping and the logical model to determine the extent to which the database elements and relationships in the physical model violates rules comprises determining whether the database elements and relationships comply with the rules indicated in the list of invariants.

31. The article of manufacture of claim 30, wherein the operations further comprise:
generating a report providing information on the extent to which database elements and relationships in the physical model violate rules in the list of variants.

32. The article of manufacture of claim 27, wherein using the logical model to generate a mapping of database names in the physical model to corresponding elements in the logical model further comprises:
processing a naming dictionary associated with the logical model to determine whether database elements in the physical model match element names defined in the naming dictionary; and
automatically generating a mapping between database elements in the physical model that match element names defined in the naming dictionary in response to determining that database elements in the physical model match element names defined in the naming dictionary.

33. The article of manufacture of claim 32, wherein the naming dictionary associates database element names with synonyms of element names of the logical model, and wherein the database element in the physical model matches one element name in the dictionary if the database element in the physical model matches one element name synonym in the naming dictionary.

34. The article of manufacture of claim 32, wherein using the logical model to generate a mapping of database names in the physical model to corresponding elements in the logical model further comprises:
receiving user input indicating a mapping between database elements in the physical model that do not match element names defined in the naming dictionary in response to determining that database elements in the physical model do not match element names defined in the naming dictionary.

35. The article of manufacture of claim 34, further comprising generating a report indicating database elements in the physical model that did not match element names defined in the naming dictionary.

36. The article of manufacture of claim 27, wherein using the logical model to generate a mapping of database names in the physical model to corresponding elements in the logical model further comprises:
determining whether there is one best fit between at least one database element in the physical model and at least one element in the logical model; and
generating a mapping between the at least one database element in the physical model having one best fit with at least one element in the logical model in response to determining that there is one best fit.

37. The article of manufacture of claim 36, wherein the operations further comprise:
generating a user interface indicating that the at least one database element in the physical model does not have one best fit with at least one element in the logical model;
receiving user selection of a mapping between the at least one database element in the physical model and at then least one element in the logical model in response to determining that there is not one best fit.

38. The article of manufacture of claim 37, wherein the operations further comprise generating a report indicating database elements in the physical model that do not have one best fit with at least one element in the logical mode.

39. The article of manufacture of claim 27, wherein the physical model comprises a first physical model, wherein the operations further comprising:
generating a second physical model having database elements from the first physical model that comply with the logical model, wherein the generated mapping is used to determine how database element names in the first physical model map to database element names in the generated second physical model.

40. The article of manufacture of claim 27, wherein the database elements comprise tables, views, relationships, functions, indexes, and fields.

41. The article of manufacture of claim 27, wherein the physical model comprises a first physical model and wherein a second physical model provides a database implementation of the logical model, and wherein the operations further comprise:
generating a user interface illustrating mappings of database element names in the first physical model to database element names in the second physical model; and
enabling the user to select one illustrated mapping to access information on the correspondence of one database element in the first physical model to one database element in the second physical.

42. The article of manufacture of claim 41, wherein illustrating the mappings in the user interface comprises:
rendering in the user interface a first list of database element names in the first physical model;
rendering in the user interface a second list of database element names in the second physical model; and
rendering lines connecting the rendered database element names in the first list to at least one rendered database element name in the second list, wherein the lines illustrate the mapping of the rendered database element names in the first list to the rendered database element names in the second list.
